(19) United States
(12) Patent Application Publication
(10) Pub. No.: US 2016/0292652 A1
(43) Pub. Date: Oct. 6, 2016

(54) PREDICTIVE ANALYTIC RELIABILITY TOOL SET FOR DETECTING EQUIPMENT FAILURES

(71) Applicants: Larry A. Bowden, JR., Houston, TX (US); Nikolaos Salmatanis, Cypress, TX (US)

(72) Inventors: Larry A. Bowden, JR., Houston, TX (US); Nikolaos Salmatanis, Cypress, TX (US)

(73) Assignee: CHEVRON PIPE LINE COMPANY, San Ramon, CA (US)

(21) Appl. No.: 14/678,775

(22) Filed: Apr. 3, 2015

(51) Int. Cl. G06Q 10/00

(52) U.S. Cl. CPC G06Q 10/20

(57) ABSTRACT

Methods and systems for predicting part reliability in energy infrastructure are disclosed. One such method includes collecting a time-series history of failures for each failure mode of a plurality of failure modes occurring in one or more energy infrastructure assets of an energy infrastructure. The method also includes fitting a failure model to each failure mode within the plurality of failure modes, and calculating a mean time between failures and a variance associated with failure time as a function of time. The method further includes calculating times of changes in each of a plurality of preventative and mitigative barriers and interrelationships among barriers to determine a schedule of inspection, maintenance, and repair activities, based on a cost of the associated activity and the failure model for each failure mode as a function of time when time series data sets representative of the associated barrier are included as process inputs.

### TECHNICAL FIELD

The present disclosure relates generally to prediction of fixed equipment failures, such as pipeline and equipment failures in an oil field or oil pipeline assets.

### BACKGROUND

Energy infrastructure assets, such as oil field or oil pipeline assets, can be prone to degradation and failure over time. However, assessing such degradation and failure, as well as performing maintenance in association with such energy infrastructure assets, is a sizable task. In particular, it is difficult to select a correct set of maintenance activities associated with such energy infrastructure assets, because each asset may degrade or fail on an independent schedule, based on its interactions with other energy infrastructure assets, or otherwise.

Typical approaches to maintenance of energy infrastructure tend to be reactive or mitigative, rather than proactive, predictive, or preventative. Even in the case of proactive maintenance activities, efforts to analytically determine how best to approach maintenance of energy infrastructure assets have traditionally related to determining a likely failure type for an asset, as well as its general frequency. Based on such failure timings and failure modes, a particular set of maintenance activities can be scheduled.

However, existing approaches have drawbacks. For example, there is no one or comprehensive standard mechanism or process for analyzing pipeline risk as a function of how inspection, maintenance, and repair affect reliability, or pipeline integrity as a function of time using a data driven approach. Mechanisms that analyze pipeline risk and/or reliability vary widely throughout the industry, and most utilize knowledge based on subjective evaluations based on individual experience with failure types, rather than applying a standard mechanism or process that utilizes a data driven analysis. Sending maintenance personnel to locations of potential failure can be costly, so inefficient allocation of maintenance activities can be a source of great expense, as is spending on ineffective maintenance activities.

Accordingly, improvements in the area of asset failure prediction and prevention are desirable.

### SUMMARY

In summary, the present disclosure relates to a predictive tool and mechanism useable to determine likelihood of fixed equipment failures, for example in an energy infrastructure such as an oil field or oil pipeline, as a function of inspection, maintenance, and repair activities. Due to the otherwise continuous maintenance efforts required, improved identification of likely failure locations and sources allows for decreased failures that affect asset integrity, production, or transportation rates of the energy infrastructure. Also, this tool and mechanism can be applied to any time-series data sets where the data sets of preventative and mitigative barriers, such as inspection, maintenance, repair, and/or failure data, are available, especially for a system or piece of a system that is not functioning as intended for a specified period of time under a set of given conditions.

In a first aspect, a method for calculating reliability in energy infrastructure is disclosed. The method includes collecting a time-series history of failures for each failure mode of a plurality of failure modes occurring in one or more energy infrastructure assets of an energy infrastructure. The method also includes fitting a failure model to each failure mode within the plurality of failure modes, and calculating a mean time between failures and a variance associated with failure time. The method further includes calculating times of changes in each of a plurality of barriers and interrelationships between barriers to determine a schedule of maintenance activities, based on a cost of the maintenance activity, a cost of a repair required in the event of a failure mode, and the failure model for each failure mode, all as a function of time.

In a second aspect, a predictive analytic reliability determination system includes a plurality of input modules, each of the plurality of input modules providing to a computing system input data regarding an operational status of an energy infrastructure asset. The system further includes a failure modeling module executable on a computing system, the failure modeling module generating, based on a history of the operational status of one or more of the energy infrastructure assets, a failure model deriving one or more causes for failure and failure events in the history of the operational status of the one or more of the energy infrastructure assets. The system also includes a failure prediction module configured to calculating a mean time between failures and a variance associated with failure time and generate one or more failure predictions as a function of time. The system includes a failure reduction optimization module configured to receive the failure predictions from the failure prediction module and develop an optimized schedule of maintenance activities based at least in part on a cost of the maintenance activity, a cost of a repair required in the event of a failure mode, and the failure model for each failure mode, wherein the optimized schedule of maintenance activities time-shifts the failure predictions for one or more of the energy infrastructure assets to temporally align with a first event occurrence.

In a third aspect, a predictive analytic reliability determination system includes a computing system including one or more computing devices each including a processor and a memory and configured to execute computer instructions, wherein the computing system is configured to, when executing such computing instructions, perform a method of predicting part reliability in energy infrastructure. The method includes collecting a time-series history of failures for each failure mode of a plurality of failure modes occurring in one or more energy infrastructure assets of an energy infrastructure, fitting a failure model to each failure mode within the plurality of failure modes, and calculating a mean time between failures and a variance associated with failure time. The method also includes calculating times of changes in each of a plurality of barriers and interrelationships among barriers to determine a schedule of inspection, maintenance, and repair activities, based on a cost of the maintenance activity, a cost of a repair required in the event of a failure mode, and the failure model for each failure mode when the barrier data sets are included as process inputs.

In a fourth aspect, a pipeline asset reliability determination system includes one or more components of a pipeline asset. The pipeline asset can be part of a transmission pipeline positioned between a first station and a second station, the transmission pipeline useable to transport materials between the first and second stations, the transmission pipeline including one or more pipeline assets selected from the group consisting of rotating and/or fixed equipment such as: a compressor or pump, a valve, a tank, a lateral feeder line, a lateral collection line, or instrumentation or measurement. The system further includes one or more failure monitors associated with the one or more components. The system also includes a computing system including one or more computing devices each including a processor and a memory and configured to execute computer instructions. The computing system is configured to, when executing such computing instructions, perform a method of predicting part reliability. The method includes collecting a time-series history of failures for each failure mode of a plurality of failure modes occurring in the one or more components based on data received from the one or more failure monitors, and fitting a failure model to each failure mode within the plurality of failure modes. The method includes calculating a mean time between failures and a variance associated with failure time to determine reliability of the one or more components based on the time-series history of failures and failure modes, and calculating times of changes in each of a plurality of barriers and interrelationships between barriers. The method further includes, based on the times of changes, the failure modes, the mean time between failures, and the variance, determine a schedule of maintenance activities associated with the one or more components based at least in part on a cost of the maintenance activity, a cost of a repair required in the event of a failure mode, and the failure model for each failure mode, all as a function of time.

In a still further aspect, a component monitoring system for pipeline assets includes a component of a pipeline asset and a monitor associated with the component. The system further includes an apparatus for recording the data from the monitor, the apparatus including a computing system including one or more computing devices each including a processor and a memory and configured to execute computer instructions, wherein the computing system is configured to, when executing such computing instructions, perform a method of predicting part reliability. The method includes collecting a time-series history of events recorded at the monitor based on data received from the monitor, and fitting a failure model to each of one or more failure modes within a plurality of failure modes associated with the component. The method further includes calculating a mean time between failures and a variance associated with failure time to determine reliability of the component based on the time-series history of events and the one or more failure modes. The method also includes calculating times of changes in each of a plurality of preventative and mitigative barriers and interrelationships among barriers, and, based on the times of changes, the one or more failure modes, the mean time between failures, and the variance, determine a schedule of maintenance activities associated with the one or more pipeline assets based at least in part on a cost of the maintenance activity, a cost of a repair required in the event of a failure mode, and the failure model for each failure mode of the one or more failure modes.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

FIG. 1 illustrates an environment in which aspects of the present disclosure can be implemented;

FIG. 2 illustrates a computing system implementing a predictive analytic reliability determination system according to an example embodiment;

FIG. 3 illustrates a flowchart of a method of predicting part reliability in energy infrastructure, according to an example embodiment;

FIG. 4 illustrates a time-series chart of failures in a particular asset illustrating barriers at different times, representing times at which failure rates may be affected by external factors and interactions of mitigative barriers to incident data;

FIG. 5 illustrates a power model to specify how a change in one aspect/strategy of a mitigative barrier affects overall failure rates;

FIG. 6 illustrates a second example flowchart of a method of predicting part reliability in energy infrastructure, according to an example embodiment;

FIG. 7 illustrates a chart of example fixed/rotating equipment failures that can be tracked in an oil pipeline infrastructure, according to an example embodiment; and

FIG. 8 illustrates a chart of fixed/rotating equipment failure modes associated with the failures of FIG. 7, and for which failure prediction can be applied.

### DETAILED DESCRIPTION

As briefly described above, embodiments of the present invention are directed to a predictive tool useable to determine likelihood of fixed/rotating equipment failures, for example in an energy infrastructure such as an oil field or oil pipeline. Due to the otherwise continuous maintenance efforts required, improved identification of likely failure locations and sources allows for decreased failures that affect production rates of the energy infrastructure. In some aspects, the present disclosure is directed to analyzing the risk, reliability, and integrity of energy infrastructure using data driven inputs of preventative and mitigative barriers, such as from inspection records, maintenance records, repair records, and incident records. Such analysis allows for efficiently allocating inspection, maintenance, and repair activities that can save substantial effort and costs while reducing failures that may otherwise occur. Furthermore, the modeling of reliability and operational costs using historical time series data inputs to build reliability models of each data set and correlating the effects on inspection models to maintenance models to repair models to incident reliability models allows for optimization of reliability/cost by adjusting inspection, maintenance, and repair activities/strategies to calculate asset reliability and associated operational costs. Thus, operational costs can be reduced and reliability can be improved without the need for capital spending.

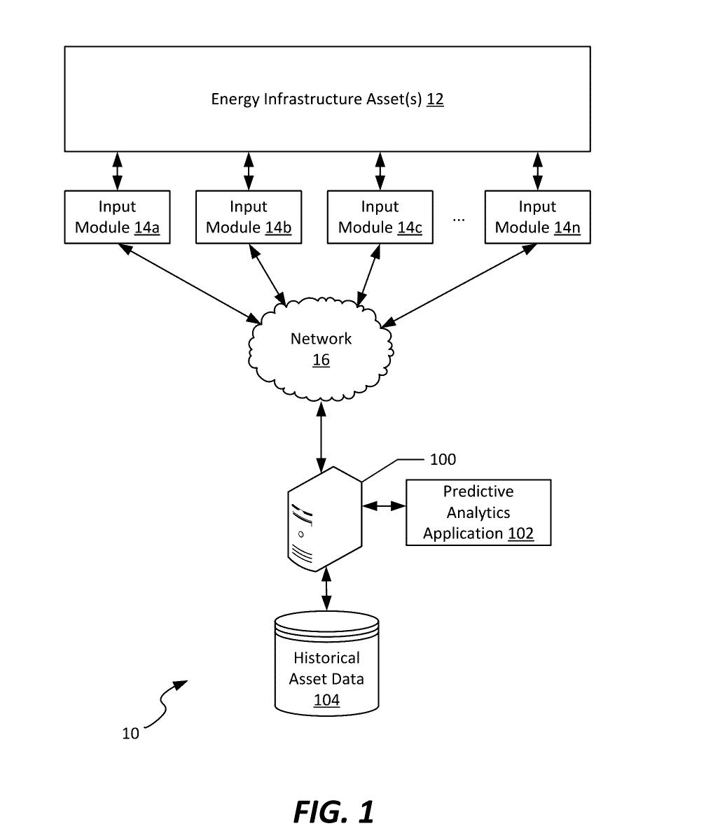

Referring first to FIG. 1, an example environment 10 in which aspects of the present disclosure can be implemented is shown. The example environment 10 includes an energy infrastructure 12. The energy infrastructure can take many forms, and encompass a variety of different types of structures and systems. In example applications, the energy infrastructure represents an oil production system, such as an oilfield or pipeline system; in such examples, the energy infrastructure system can include boring equipment and wells or other oil extraction equipment, pipeline segments, or components of a pipeline or maintenance equipment useable with such a pipeline and for which failures may affect oil production and/or transport. In particular examples, the energy infrastructure 12 can be a transmission pipeline or segment thereof that is positioned between transport stations. In such an embodiment, the transmission pipeline can transport, for example, solids, gases, liquids, or mixtures thereof between two points (e.g., the two transport stations). In further example, the energy infrastructure can include a processing facility, and can include any components or features of such a facility at which failures may occur. Example types of pipeline assets that can be included in such an energy infrastructure, when that energy infrastructure is a pipeline, can include rotating and fixed equipment such as: a compressor or pump, a valve, a tank, a lateral feeder line, a lateral collection line, instrumentation or measurement, or a combination thereof.

Failures in an energy infrastructure may come from a variety of sources. For example, latent failures may exist that reside in an organization and step from decisions made at an earlier time, such as poor designs, incorrect procedures, or inadequate supervision. Active errors may also exist in an energy infrastructure asset, which correspond to an error directly linked to an incident. These can include worker behaviors, such as distracted work or wrong decisions. Typically, observed failure rates may be decreasing early in equipment or service life due to issues relating to new equipment incompatibilities; additionally, wear typically occurs later in service life and increases failure rates at that time. Lower, constant failure rates are typically present during mid-life of a particular asset.

In the embodiment shown, the environment includes a plurality of input modules 14a-n (referred to collectively as input modules 14). The input modules 14 are interfaced to the energy infrastructure, and capture information associated with the energy infrastructure. The input modules can take a variety of forms. In some cases, the input modules can include sensors located at a facility or along a pipeline and which are configured to report an operational status of the pipeline. This can include, for example, flow rates, flow volume, or other observed characteristics in the case of a pipeline; it could alternatively include operational status of various processing equipment. In some cases, the input modules 14 correspond to computing systems or other mechanisms for reporting operational status of an energy infrastructure useable by maintenance personnel to report operational status of a particular physical or operational feature of the energy infrastructure asset.

In the example embodiment shown, data from the input modules 14 is received at a computing system 100 useable to implement a predictive analytic reliability determination associated with the energy infrastructure asset. The computing system stores the data from the input modules 14 in a database, such as historical asset database 104. The historical asset database stores various conditions associated with energy infrastructure assets and characterizations of failures.

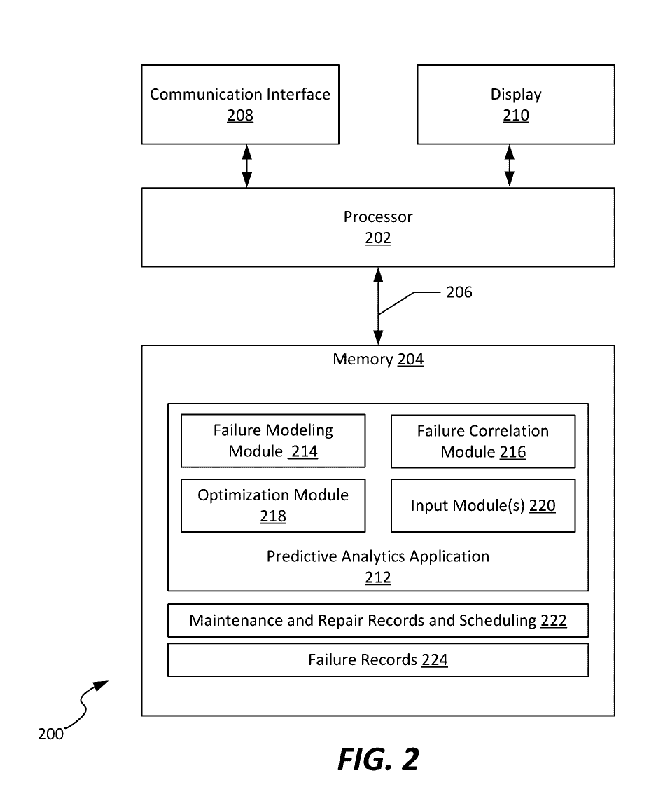

The computing system 100 can also host a predictive analytics application 102, discussed in further detail in connection with FIG. 2. The predictive analytics application 102 generally is used to analyze captured data associated with one or more energy infrastructure assets (e.g., from historical asset database 104). The predictive analytics application 102 can be used to determine, from the captured data, the existence of one or more failures, as well as to characterize the one or more failures associated with an energy infrastructure asset. Those failures can then be associated with one or more root causes, and average times associated with such failures determined by determining an average time between occurrences of those root causes from which a failure may stem. In alternative applications, the predictive analytics application 102 need not perform a root cause analysis, but rather performs a statistical analysis on the data associated with one or more energy infrastructure assets to determine a likely time between failures of a particular type. From the failure frequency and timing information, one or more reports can be generated that provide information regarding a preferred timing for maintenance of such energy infrastructure assets that would best allocate maintenance resources at a reduced cost, while avoiding or reducing failures that may have a detrimental effect on performance of the energy infrastructure.

Although illustrated as a single computing system 100, it is noted that the computing system can include any of a number or variety of computing systems, including variations in which a cloud-based or centrally located server system interfaces to one or more remote computing systems at which a user can input information about energy infrastructure assets (e.g., implementing example aspects of the input modules 14) and to view and interact with the predictive analytics application 102. The predictive analytics application 102 can then be hosted centrally or via a cloud-based computing arrangement that is accessible to maintenance planning personnel.

Referring now to FIG. 2, a computing system 200 implementing a predictive analytic reliability determination system is shown, according to an example embodiment. The computing system 200 can, in example embodiments, correspond to the computing system 100 of FIG. 1, above.

FIG. 2 shows a schematic block diagram of a computing system 200. The computing system 200 can be, in some embodiments, used to implement a predictive analytic reliability determination according to the present disclosure. In general, the computing system 200 includes a processor 202 communicatively connected to a memory 204 via a data bus 206. The processor 202 can be any of a variety of types of programmable circuits capable of executing computer-readable instructions to perform various tasks, such as mathematical and communication tasks.

The memory 204 can include any of a variety of memory devices, such as using various types of computer-readable or computer storage media. A computer storage medium or computer-readable medium may be any medium that can contain or store the program for use by or in connection with the instruction execution system, apparatus, or device. By way of example, computer storage media may include dynamic random access memory (DRAM) or variants thereof, solid state memory, read-only memory (ROM), electrically-erasable programmable ROM, optical discs (e.g., CD-ROMs, DVDs, etc.), magnetic disks (e.g., hard disks, floppy disks, etc.), magnetic tapes, and other types of devices and/or articles of manufacture that store data. Computer storage media generally includes at least one or more tangible media or devices. Computer storage media can, in some embodiments, include embodiments including entirely non-transitory components. In the embodiment shown, the memory 204 stores a predictive analytics application 212, discussed in further detail below. The computing system 200 can also include a communication interface 208 configured to receive and transmit data, for example one or more data streams received from input modules 104 as seen in FIG. 1. Additionally, a display 210 can be used for presenting a graphical display of the predictive analytics application 212, viewing reports associated with failures of an energy infrastructure asset, or other information.

In various embodiments, the predictive analytics application 212 includes a failure modeling module 214, a failure correlation module 216, an optimization module 218, and input modules 220. The memory 204 can also store maintenance and repair records and scheduling information 222, as well as failure records 224.

The failure modeling module 214 is configured to generate, based on a history of the operational status of one or more of the energy infrastructure assets, a failure model deriving one or more causes for failure and failure events in the history of the operational status of the one or more of the energy infrastructure assets. In example embodiments, the failure modeling module 214 can determine causes for failures based, for example, on reported events causing failures, interactions with other failing equipment, or other features of an energy infrastructure.

The failure correlation module 216 can use the failure models to calculate a mean time between failures and a variance associated with failure time and generate one or more failure predictions. The failure correlation module can, in some such embodiments, determine when a next failure is likely to occur based on the mean time between failures and models developed in the failure modeling module, and pass those predictions to the optimization module 218.

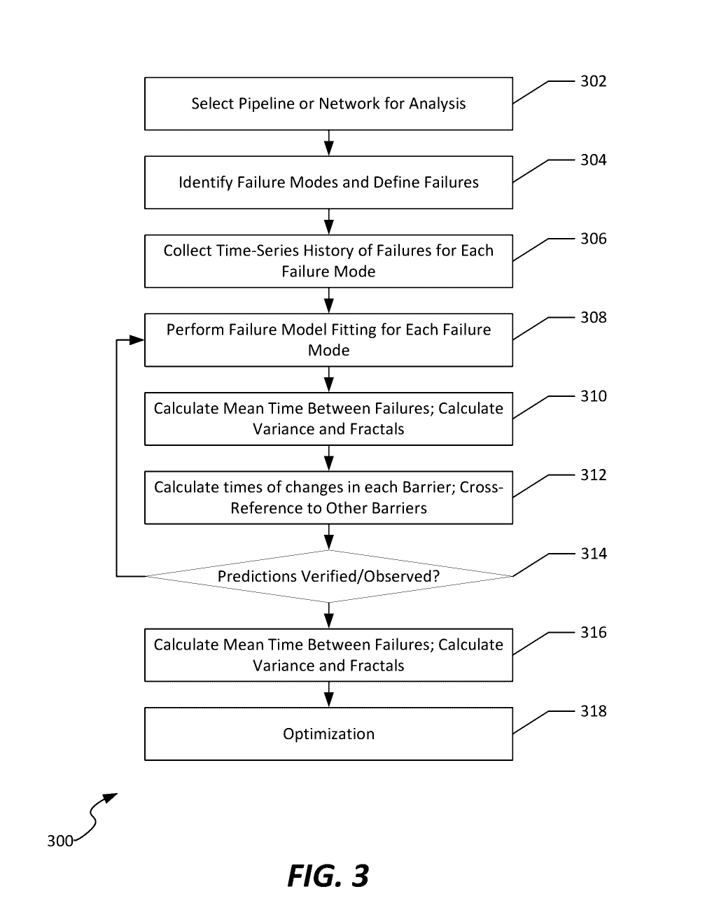

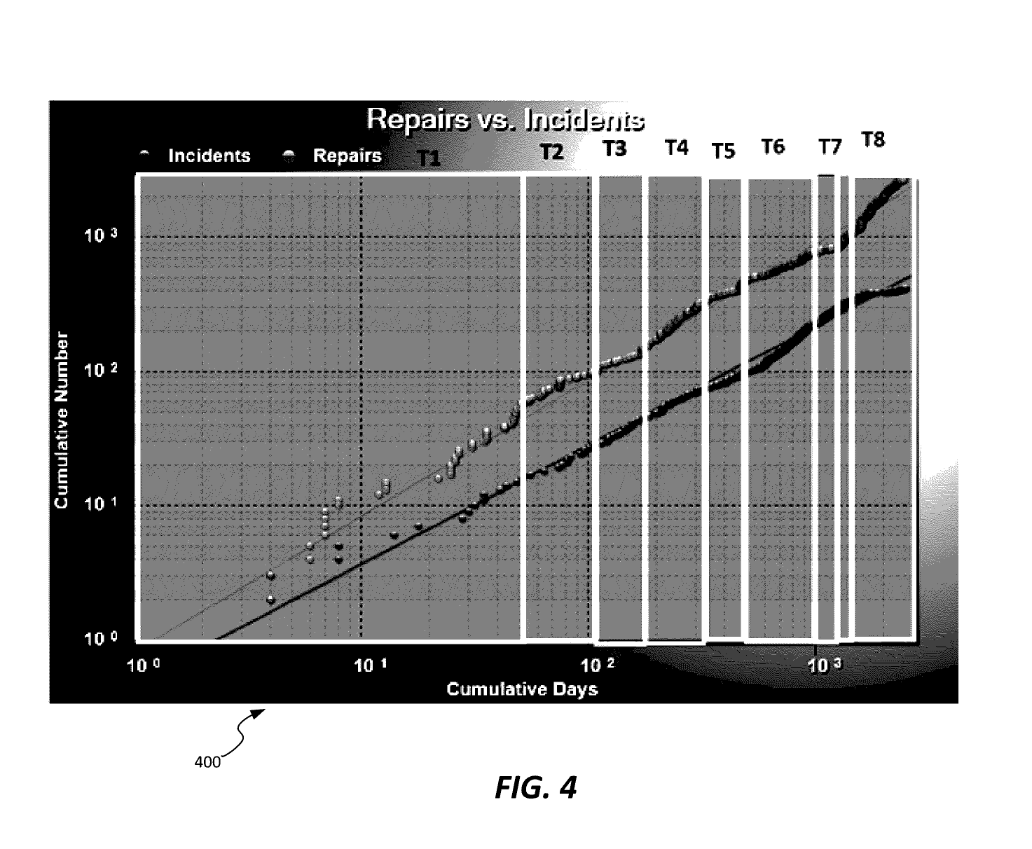

The optimization module 218 receives the failure predictions from the failure prediction module and develops an optimized schedule of maintenance activities to be performed on the energy infrastructure asset. The failure predictions can be based, for example, on a cost of the maintenance activity, a cost of a repair required in the event of a failure mode, and the failure model for each failure mode. The optimize schedule of maintenance activities can be generated, for example, by time-shifting failure predictions to temporally align with a first failure occurrence, thereby synchronizing the failures to ensure accurate interrelationships among potential failures of assets. Further details regarding optimization and failure predictions, as well as maintenance scheduling, are described below in connection with FIGS. 3-4.

The input modules 220 provide input data regarding an operational status of an energy infrastructure asset. This input data can include, for example, a list of incidents, repairs, maintenance, inspection, human factors, and environmental correlations. The input data can include, for example, periodically monitored features of an energy infrastructure asset such as a pipeline, or can simply include failure events, including a description of the type of event, severity, its cause, and time of its occurrence. Other types of data can be received by the input modules as well.

Referring now to FIG. 3, a flowchart of a method 300 of predicting part reliability in energy infrastructure is illustrated, according to an example embodiment. The method 300 can be performed, for example using the predictive analytics application 212 of FIG. 2.

In the example embodiment shown, the method 300 includes selecting an energy infrastructure asset for analysis (step 302). This sets the system boundaries and determines the extent of supporting data needed.

The asset can be, for example, a pipeline or network for which failures are tracked and for which maintenance is performed. The method can include identification of failure modes and definition of failures associated with those failure modes (step 304). The various data typically used for determination of optimized maintenance and failure prevention or reduction can include maintenance, repair, and incident data.

Typically, this data is received as time series data of failures, as defined by the analysis objective. For example, inspection failures can be defined to be any action taken due to inspection activity or date of an inspection activity. Maintenance failures can be defined as any unplanned maintenance activity, or the date of any maintenance activity performed. Repair failures can correspond to any unplanned repair, and repair performed, or date of any type of repair. Finally, incident failures can represent any unplanned incident, any incident occurrence, or the date of any incident type. Once failure modes are defined, a time-series history of failures for each failure mode can be aggregated (step 306). In other words, each type of failure can be classified and aggregated, alongside the times at which such failures occurred. This is simply the date/time of the failure starting from the time that data is available. The times for each data set should be synchronized when comparing the effects of one data set to the other.

After the time-series collections of failures based on failure mode are collected, a failure model fitting can be performed (step 308). The failure model fitting can include use of CROW-AMSAA, Weibull, or any failure model of interest fit to each individual data set. Validation of the model to the data is used to determine the modeled confidence.

After the failure model fitting, failure model parameters can be used to calculate mean time between failure/variance/fractals, and reliability over the time of interest (step 310). The reliability over the time of interest can be, for example, usually a set time period of interest or the expected life span of the system. Alternatively, the expected life span of the system can be determined by stating the desired mean time between failure (MTBF) and/or a desired reliability target.

Furthermore, because the models used typically have a linear time-series relationship for cumulative failures (as plotted on a log scale), where inflection points are observed, a change in line scope can be correlated to potential changes in other data sets concurrent with the failures in the particular series. Accordingly, this correlation can be performed (step 312) to determine how reliability/cost/MTBF for incidents is affected by changes to pipeline inspection, maintenance, and repair strategies.

Once the times of changes in each barrier are determined and inflection points are observed and analyzed to determine how to address maintenance issues, a validation process can be performed (step 314). The validation process determines whether the observed reliability or incident rates match the model predictions. If there is a good match between observed and predicted reliability, a further calculation process can be performed (step 316) in which mean time between failures can be further analyzed and calculated, alongside variance and fractals as data further develops. However, if there is not a good match, operational flow returns to step 308 to re-fit failure models and failures to different failure modes, and re-develop model parameters with updated data to obtain a better match.

At step 316, if observations match the model predictions, then the mean time between failure, reliability, operational costs, variances, and system fractals may be known with a corresponding confidence. Accordingly, inspection, maintenance, and repair strategies can be optimized (at step 318) to increase asset reliability and/or reduce operational costs with the determined confidence as derived from the failure models.

Referring back to step 312, further details regarding correlation are discussed. In particular, it is noted that the models in step 310 are typically to be included as trending in a straight line of cumulative failures on a log-log scale graph of time against number of incidents. If an inflection point is detected, a change in line scope may correlate to potential changes in a different data set at the same time. Accordingly, a result of that change represent correlation of how reliability/cost/MTBF for incidents is affected by changes to pipeline inspection, maintenance, and repair strategies.

Generally, reliability modeling using existing field equipment requires that models start at the occurrence of the first event. These models are said to contain left justifications, or data previous to the time of the first record. To align the reliability models of multiple data sets, the data of the first event is used as the starting condition. If other reliability models start on dates after the first event, the models are time shifted to match the first event of the earliest occurrence of all models. Accordingly, and by way of example, Table 1 below illustrates an example set of repairs, and Table 2 below illustrates an example set of incidents.

TABLE 1
Repairs

| | Date of First | Days since first | Time |
|---|---|---|---|
| Date | Event | event | shift |
| Jan. 1, 2010 | Jan. 1, 2010 | 1 | 0 |
| Feb. 1, 2010 | Jan. 1, 2010 | 32 | 0 |
| Mar. 1, 2010 | Jan. 1, 2010 | 60 | 0 |
| Apr. 1, 2010 | Jan. 1, 2010 | 91 | 0 |
| May 1, 2010 | Jan. 1, 2010 | 121 | 0 |
| Jun. 1, 2010 | Jan. 1, 2010 | 152 | 0 |
| Jul. 1, 2010 | Jan. 1, 2010 | 182 | 0 |
| Aug. 1, 2010 | Jan. 1, 2010 | 213 | 0 |
| Sep. 1, 2010 | Jan. 1, 2010 | 244 | 0 |
| Oct. 1, 2010 | Jan. 1, 2010 | 274 | 0 |
| Nov. 1, 2010 | Jan. 1, 2010 | 305 | 0 |
| Dec. 1, 2010 | Jan. 1, 2010 | 335 | 0 |

TABLE 2
Incidents

| | Date of First | Days since first | Time |
|---|---|---|---|
| Date | Event | event | shift |
| Mar. 1, 2010 | Mar. 1, 2010 | 1 | 59 |
| Jun. 1, 2010 | Mar. 1, 2010 | 93 | 59 |
| Sep. 1, 2010 | Mar. 1, 2010 | 185 | 59 |
| Dec. 1, 2010 | Mar. 1, 2010 | 276 | 59 |

For each set of data, the days since first event is used as the primary input into CROW-AMSAA or Weibull reliability models. The time shift is used after developing the models to align the graphs of each model to the same starting date (1/1/2010) in this case. The process is the same when analyzing multiple data sets (inspection, maintenance, repair, incidents).

When the data is aligned, it is necessary to look for three inflection points in the reliability model of inspection data. These points are used to develop separate models using the data contained within the time window. An example of such inflection point analysis is provided in FIG. 4, which illustrates a chart 400 on a log-log scale of failures in a particular asset over time. As illustrated in FIG. 4, the chart is separated into regions at which a best-fit line to the data changes in slope, indicating an effect of some other feature on the failures that are observed. Such an effect can correspond, for example, to maintenance or failure of a related asset, or maintenance associated with that asset. Accordingly, each asset to be observed can have such a process repeated thereon, using reliability model data associated with inspection and maintenance failures, maintenance and repair failures, or repair and incident failures.

This allows the computation of how changes to inspections affect maintenance affect repair rates affect incident rates. This allows the optimization of reliability models by adjusting inspection, maintenance, and repair strategies. The also allows more accurate cost optimization and forecasting.

A table of the beta and lambda reliability coefficients can be built for each time frame, for example as shown in Table 3, below:

TABLE 3

| | |
|---|---|
| Repair | Incidents |

| | Beta | Lambda | Beta | Lambda |
|---|---|---|---|---|
| T1 | 0.8 | 0.5 | 1.1 | 1.2 |
| T3 | 1.1 | 0.5 | 0.95 | 1.6 |
| T4 | 1.2 | 0.8 | 0.9 | 1.8 |
| T5 | 1.3 | 1 | 0.85 | 2 |
| T6 | 1.4 | 1.2 | 0.8 | 2.2 |
| T7 | 1.5 | 1.4 | 0.75 | 2.4 |
| T8 | 1.6 | 1.8 | 0.7 | 2.7 |
| T9 | 1.7 | 2 | 0.65 | 3 |

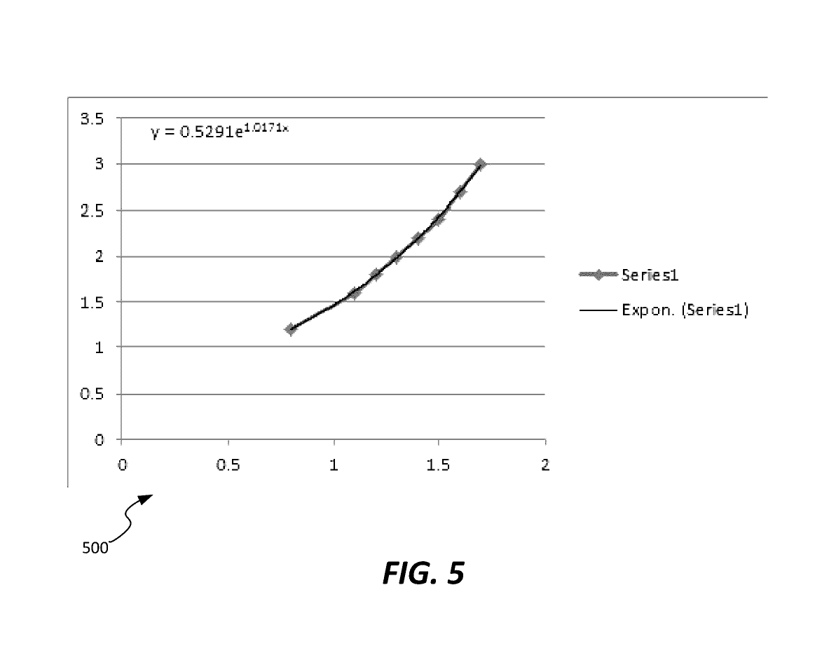

In Table 3, the coefficients are then fitted to a power model to specify how a change in one affects the other (shown in chart 500 of FIG. 5). Accordingly, over a specified time period, the reliability and confidence of the risk of a pipeline asset experiencing an incident is calculated in addition to the risk of the incident. The rate of inspection activities, maintenance activities, repair activities, and incidents is known and greatly improves operation and maintenance cost estimation while improving asset reliability with focused efforts in the proper areas.

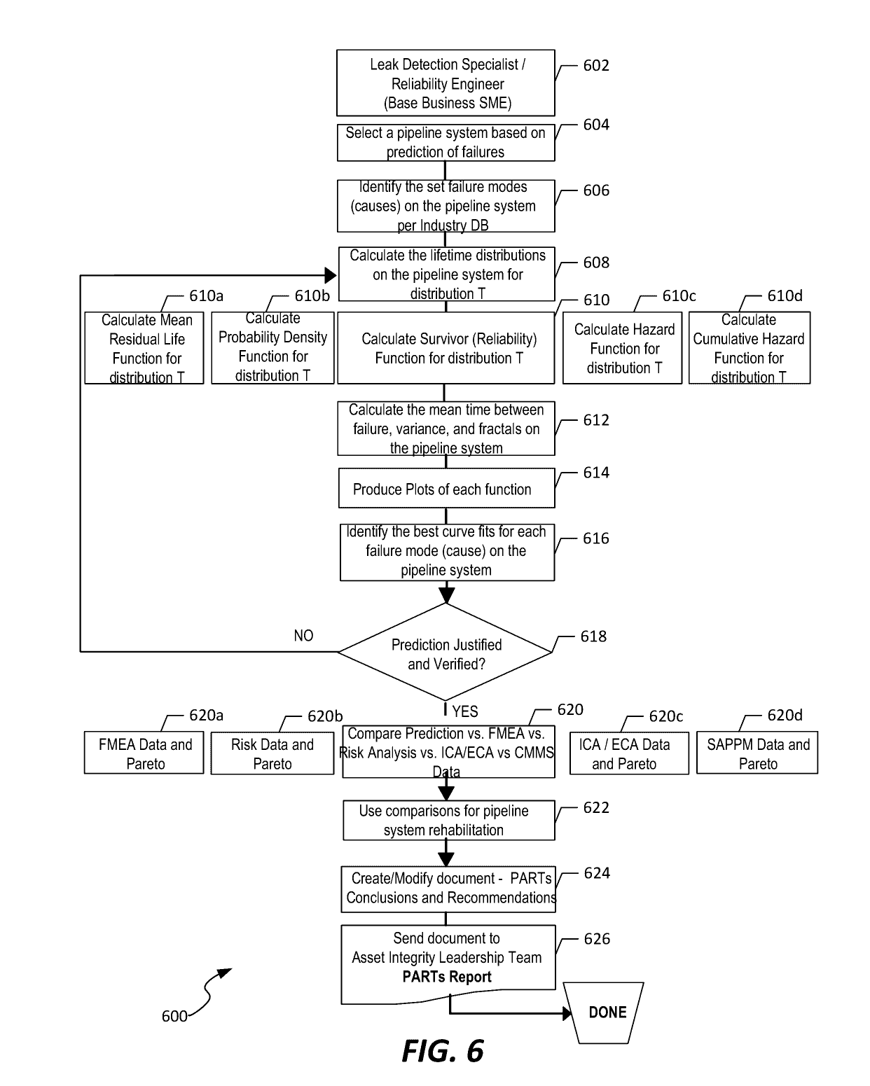

Referring now to FIG. 6, a second example flowchart of a method 700 of predicting part reliability in energy infrastructure is shown, according to an example embodiment. The method 600 generally represents a particular example of the methodology described above in connection with FIG. 3, as applied to an oil pipeline as an example of an energy infrastructure asset.

In the embodiment shown, a leak detection specialist or reliability engineer may operate a system for analyzing maintenance and predicting failures (step 602). The individual may select a pipeline system to be analyzed based on prediction of failures (step 604). A set of failure modes, or causes of failures, are detected on the pipeline system (step 606). A lifetime distribution of failures is calculated for a distribution T (step 608).

Once lifetime distributions are calculated, a survivor function (i.e., reliability) for a particular distribution T based on one or more variables (step 610). This can be done in any of a variety of ways. For example, a mean residual life function can be calculated for the distribution T (step 610a). A probability density function could also be calculated for the distribution T (step 610b). A hazard function could also be calculated for the distribution T (step 610c). Finally, a cumulative hazard function could also be calculated for the distribution T (step 610d).

Upon calculating survivor functions, a mean time between failure, variance, and fractals on the pipeline system are calculated (step 612). Plots of each function can be generated, for example as illustrated in FIG. 4, above (step 614). Best curve fits can be identified for each failure mode (step 616).

If, after best curve fits are determined, a prediction is not verifiable (as determined at step 618), the lifetime distributions are recalculated based on updated data (step 608). However, if the best curve fits are verified, a comparison of a predicted failure is made relative to risk analysis and other failure data (step 620). That can be accomplished in a variety of different ways. For example, in a first comparison, FMEA data and Pareto data can be compared (step 620a). Alternatively, risk data and Pareto data can be compared (step 620b). ICA/ECA data and Pareto data can be compared (step 620c). Or, SAPPM data and Pareto data can be compared (step 620d). Other comparisons may be possible as well.

A comparison for pipeline system rehabilitation can be made (step 622) for example to determine a possible maintenance activity that may affect failure rates or failure costs. A report may be generated and/or modified, for example to provide conclusions or recommendations regarding a selected set of cost-optimized maintenance or failure mitigation activities (step 624). The document can then be sent to other individuals within an organization, such as asset integrity leadership.

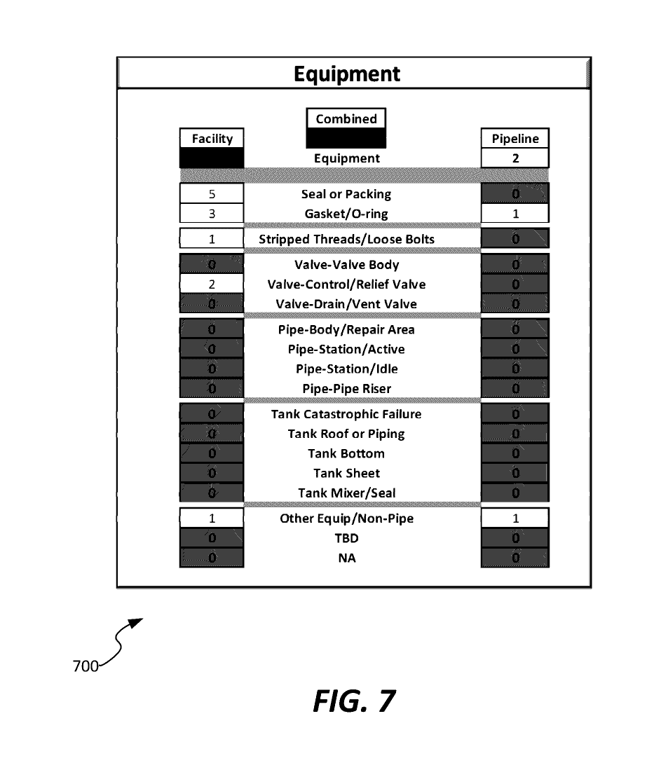

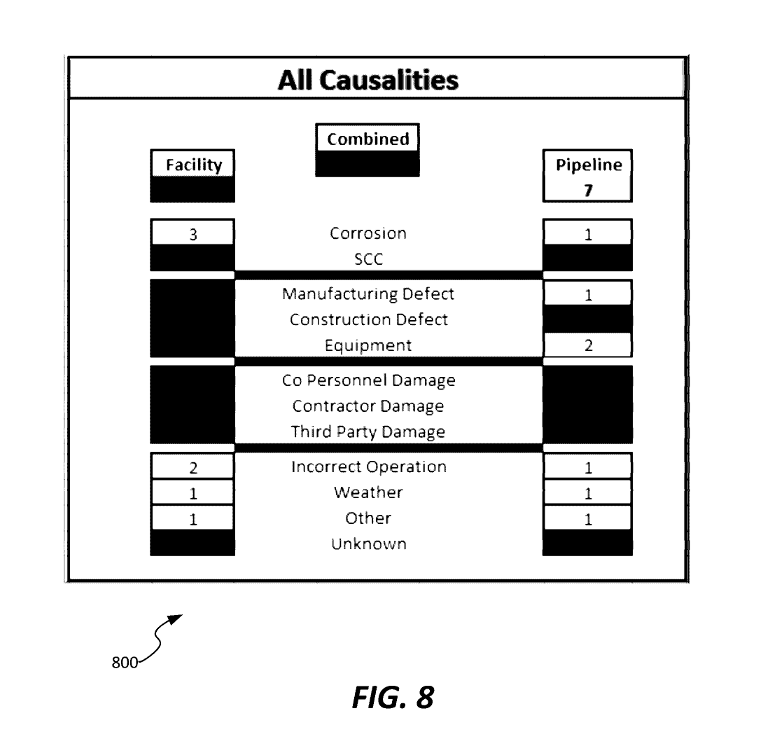

FIGS. 7-8 illustrate example equipment and causalities in an energy infrastructure context that can fail, and causes of such failures. As illustrated in the graphical report 700 of FIG. 7, a combination of 12 facility and 2 pipeline failures are reported and root-caused to different features of such assets. As illustrated in the graphical report 800 of FIG. 8, failure modalities are described, in which features such as corrosion, incorrect operation, or equipment defects cause such failures. By assessing such failures over time, the reliability and confidence of the risk of a pipeline asset experiencing an incident is calculated in addition to the risk of the incident. The rate of inspection activities, maintenance activities, repair activities, and incidents is known and greatly improves operation and maintenance cost estimation while improving asset reliability with focused efforts in the proper areas.

Referring generally to the systems and methods of FIGS. 1-8, and referring to in particular computing systems embodying the methods and systems of the present disclosure, it is noted that various computing systems can be used to perform the processes disclosed herein. For example, embodiments of the disclosure may be practiced in various types of electrical circuits comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, aspects of the methods described herein can be practiced within a general purpose computer or in any other circuits or systems.

Embodiments of the present disclosure can be implemented as a computer process (method), a computing system, or as an article of manufacture, such as a computer program product or computer readable media. The term computer readable media as used herein may include computer storage media. Computer storage media may include volatile and nonvolatile, removable and non-removable media implemented in any method or technology for storage of information, such as computer readable instructions, data structures, or program modules. Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing system 300, above. Computer storage media does not include a carrier wave or other propagated or modulated data signal. In some embodiments, the computer storage media includes at least some tangible features; in many embodiments, the computer storage media includes entirely non-transitory components.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the claimed invention and the general inventive concept embodied in this application that do not depart from the broader scope.

1. A method of predicting part reliability in energy infrastructure, the method comprising:
collecting a time-series history of failures for each failure mode of a plurality of failure modes occurring in one or more energy infrastructure assets of an energy infrastructure;
fitting a failure model to each failure mode within the plurality of failure modes;
calculating a mean time between failures and a variance associated with failure time; and
calculating times of changes in each of a plurality of barriers and interrelationships between barriers to determine a schedule of maintenance activities, based on a cost of the maintenance activity, a cost of a repair required in the event of a failure mode, and the failure model for each failure mode.

2. The method of claim 1, further comprising verifying accuracy of the failure model based on observations of failures in the energy infrastructure.

3. The method of claim 2, further comprising calculating an updated mean time between failures and an updated variance associated with the updated failure time.

4. The method of claim 3, further comprising optimizing a schedule of maintenance activities based at least in part on cost of the maintenance activity, cost of a repair required in the event of a failure mode, and a failure model for the failure mode.

5. The method of claim 3, wherein the schedule of maintenance activities includes inspection, maintenance, and repair activities associated with the one or more energy infrastructure assets.

6. The method of claim 1, wherein fitting a failure model to each failure mode includes calculating a mean residual life of each energy infrastructure asset, a probability density for the failure mode, a survivor function, a reliability value, a confidence value, and a cumulative hazard function.

7. The method of claim 6, wherein the cumulative hazard function corresponds to an amount of cumulative risk to which the energy infrastructure is exposed at a predetermined time.

8. The method of claim 1, wherein a mean residual life corresponds to a time between failures adjusted by a current age of the energy infrastructure asset.

9. The method of claim 1, wherein calculating the times of changes in each of a plurality of barriers and interrelationships between barriers to determine a schedule of maintenance activities includes aligning reliability models for each of a plurality of energy infrastructure assets based on a first event occurring relating to an energy infrastructure asset.

10. The method of claim 9, wherein aligning reliability models for each of a plurality of energy infrastructure assets includes time-shifting models for one or more of the energy infrastructure assets to temporally align with the first event occurrence.

11. A predictive analytic reliability determination system comprising:
a plurality of input modules, each of the plurality of input modules providing to a computing system input data regarding an operational status of an energy infrastructure asset;
a failure modeling module executable on a computing system, the failure modeling module generating, based on a history of the operational status of one or more of the energy infrastructure assets, a failure model deriving one or more causes for failure and failure events in the history of the operational status of the one or more of the energy infrastructure assets; and
a failure prediction module configured to calculate a mean time between failures and a variance associated with failure time and generate one or more failure predictions;
a failure reduction optimization module configured to receive the failure predictions from the failure prediction module and develop an optimized schedule of maintenance activities based at least in part on a cost of the maintenance activity, a cost of a repair required in the event of a failure mode, and the failure model for each failure mode, wherein the optimized schedule of maintenance activities time-shifts the failure predictions for one or more of the energy infrastructure assets to temporally align with a first event occurrence.

12. The system of claim 1, wherein the failure reduction optimization module is further configured to verify accuracy of the failure model based on reported user observations of failures in the energy infrastructure.

13. The system of claim 1, wherein the computing system includes a plurality of computing devices, the system further comprising a database storing historical information regarding operational status of the energy infrastructure asset.

14. A pipeline asset reliability determination system comprising:
one or more components of a pipeline asset;one or more failure monitors associated with the one or more components;
a computing system including one or more computing devices each including a processor and a memory and configured to execute computer instructions, wherein the computing system is configured to, when executing such computing instructions, perform a method of predicting part reliability, the method comprising:
collecting a time-series history of failures for each failure mode of a plurality of failure modes occurring in the one or more components based on data received from the one or more failure monitors;
fitting a failure model to each failure mode within the plurality of failure modes;
calculating a mean time between failures and a variance associated with failure time to determine reliability of the one or more components based on the time-series history of failures and failure modes;
calculating times of changes in each of a plurality of preventative and mitigative barriers and interrelationships among barriers; and
based on the times of changes, the failure modes, the mean time between failures, and the variance, determine a schedule of maintenance activities associated with the one or more pipeline assets based at least in part on a cost of the maintenance activity, a cost of a repair required in the event of a failure mode, and the failure model for each failure mode.

15. The pipeline asset reliability determination system of claim 14, further comprising a transmission pipeline positioned between a first station and a second station, the transmission pipeline useable to transport materials between the first and second stations and including the pipeline asset, wherein the pipeline asset comprises rotating or fixed equipment and includes one or more of: a compressor or pump, a valve, a tank, a lateral feeder line, a lateral collection line, or instrumentation or measurement equipment.
